(19) United States
(12) Patent Application Publication
(10) Pub. No.: US 2020/0060105 A1
(43) Pub. Date: Feb. 27, 2020

(54) MOBILE LAWN SURFACE GROWTH SYSTEM

(71) Applicant: TSM GMBH, Stolberg (DE)

(72) Inventor: Georg Tsivikis, Stolberg (DE)

(21) Appl. No.: 16/654,347

(22) Filed: Oct. 16, 2019

Related U.S. Application Data
(63) Continuation of application No. PCT/DE2016/000186, filed on May 4, 2016.

(30) Foreign Application Priority Data
May 12, 2015 (DE) DE102015005947.5
Oct. 6, 2015 (DE) DE102015012860.4

(51) Int. Cl. A01G 20/30; A01G 25/09; A01G 7/04; H05B 37/02; H05B 33/08

(52) U.S. Cl. CPC A01G 20/30; A01G 25/09; H05B 33/0854; H05B 37/0227; A01G 7/045

(57) ABSTRACT

A mobile illumination device including a movable frame running on wheels; and a panel mounted on the movable frame and including infrared radiators and LED radiators.

### RELATED APPLICATIONS

This application is a continuation of International application PCT/DE2016/000186 filed on May 4, 2016 claiming priority from German patent applications DE 10 2015 005 947.5 filed on May 12, 2015 and DE 10 2015 012 860.4 filed on Oct. 6, 2015, each of which are incorporated in their entirety by this reference.

### FIELD OF THE INVENTION

The invention relates to a mobile lighting system including a movable frame and a panel, which includes ultraviolet (UV) emitters.

### BACKGROUND OF THE INVENTION

For the lighting of turfed areas, for example, in football stadiums or on golf courses, lighting systems with a movable frame have been proposed in order to ensure a defined illumination over a specific period of time. In order to stimulate growth of the plants, such lighting systems can have a panel with LED lamps. This leads to an illumination of the soil and thus to more intensive plant growth.

Such a lighting system is known from WO 2015/028883. There, sprinklers are proposed for the irrigation of plants and different light sources for the illumination, which are specifically tailored to the type of plants to be illuminated.

WO 2011/086499 shows how a grass surface can be heated by thermal convection.

### BRIEF SUMMARY OF THE INVENTION

The object of the invention is to further develop such the generic mobile lighting system described supra.

This object is achieved by a mobile lighting system in which the panel has infrared emitters that can be used independently from the UV emitters, in order to heat up a turfed area or an area of ground at least on its surface, and thus to ensure illumination by the LED lamps, heating by the infrared emitters.

Surprisingly it has been found that infrared emitters can be additionally used on the panels on which the LED lamps are mounted, in order to extend the light spectrum in terms of its wavelength. This system thus allows three functions: lighting, heating and watering.

Particularly in football stadiums, as a result of their design, areas are created that are less well supplied with sunlight than other areas. This leads to different rates of grass growth on the turfed area, even when optimum heat and moisture conditions prevail.

The LED lamps, which are implemented as UV emitters and have a complementary light spectrum to that of the infrared emitters, allow the grass surface to be illuminated during the watering and heating. In particular, the areas of grass which are often shaded can be illuminated.

A specific selection of the emitters is made with the goal, on the one hand side, of heating the soil at least on its surface, and on the other hand side, of providing optimum illumination for the turf plants. A fine atomization of the water at the water nozzles allows the atomized water to be heated up by several degrees Celsius on the way between the nozzle and the turf. This is very beneficial for the growth of the grass, especially in winter. This allows a mist to be generated, which although it impedes the penetration of the radiation from the emitters to the grass, nevertheless heats up the sprayed water and thus causes a gentle warming of the turf, which also heats a top layer of the soil as the water penetrates into the soil. A particularly preferred method for operating the mobile lighting system is therefore one in which the water nozzles and water pressure are set such that the water is atomized.

Depending on the season and light conditions, infrared emitters can be used in the winter time in order to heat up the turf, and in the summer, the system can also be operated exclusively with UV emitters and watering.

It is advantageous if a large grass surface can be evenly illuminated, heated and watered with the mobile lighting system. It is therefore proposed that the panel has a plurality of fold-out panel elements for a span of more than 1 meter, and preferably of several meters. The fold-out panel elements make it possible to store the movable frame with the panel with the panel elements folded down, and for the panel elements to be folded out for use in such a way that they can cover a horizontal flat surface area of several meters. The frame can be preferably folded out to a distance of over 10 m and travel over the playing field independently, in order to ensure optimum illumination.

For storing the lighting system, the panel elements can be folded in and the system can then be moved off the playing field.

If the turfed areas to be treated are larger than the available panel, the panel with the movable frame is moved over the grass surface. In doing so the supply tube to the frame, which usually supplies water and electricity, must not be prevented from moving over the grass surface. However, this is detrimental to the grass growth in the areas in which the tube is resting on the grass surface.

A reel is therefore proposed, around which a tube leading to the frame is wound. This makes it possible to keep the tube as short as possible and preferably held taut at all times, in such a way that it does not rest on the grass surface. If the length of the tube between the frame and the supply to the tube is very long, the tube can be kept away from the grass surface using simple supports. A linear movement of the frame combined with a stationary reel results in a defined course of the tube and allows the tube to be supported above the grass surface.

While the frame is moved over the grass surface, preferably in a straight line, it is necessary, however, to move the frame over the grass surface and, if necessary, to position a plurality of frames on the grass surface relative to each other. For this purpose, it is advantageous if the frame has a draw shaft.

If the system is equipped with a controller, it will be possible to move it fully automatically by remote control. For this purpose, controllers with position detection, such as GPS or GNSS systems and excavator control systems are preferably used.

If the lighting system is also positioned on the grass surface, a slow continuous linear motion of the frame and thus of the panel relative to the grass surface is therefore required. For this purpose, it is advantageous if the frame has one and preferably two motors. Depending on the design, the frame can also have a plurality of motors. This allows the frame to be driven in straight lines not only across the grass surface, but also from the grass surface into a parked position, to free up the grass surface to be used for sport.

A simple, fast and individual movement of the frame is provided by an independent wheel suspension. In this case, the wheels should be designed so that they exert little pressure on the grass surface.

It is therefore proposed that the frame has rubber tires. These tires have low air pressure, so that the wheel surface is in contact with a fairly large region of the grass surface. A system for a larger grass surface has a plurality of movable frames, each with one panel, that can be moved jointly. These frames are preferably moved over the grass surface by remote control, wherein the panels of different movable frames can be connected together and/or moved in such a synchronized manner that they are moved relative to the grass surface like a common surface.

On the one hand a distance from 1 meter to 1.5 meters between the grass surface and the panel is particularly advantageous, in order to distribute the light and the water from the pan& particularly evenly over the underlying grass surface.

On the other hand side, it is advantageous if the frames can also be moved manually, without the operators being impeded by the panels. It is therefore proposed that the height of the panel on the frame is adjustable from approximately 1.4 m to approximately 1.9 m, preferably from 1.2 m to 2 m.

On the one hand side, this enables the panel to be held at an optimum distance from the grass surface and, on the other hand, the space underneath the panel to be accessed on foot to move the frame or to perform maintenance work.

In the winter, the blades of grass of the turf can become frozen over. Ice crystals on the stems, or even a layer of ice, causes the grass stems to become particularly susceptible to breakage. It is therefore proposed that the frame has tires by which it can be moved over the ground, and a heating device is directed at the ground in the direction of travel thereof.

This allows the ground with the grass stems to be partially heated, either directly in front of the tires or further away from the tires or wheels in the direction of travel.

If the tires roll over the preheated grass surface, they are able to bend the blades of grass without breaking them.

As this problem occurs mainly in the winter and a heating device would give rise to additional weight, it is proposed that the heating device is removable. It can therefore be screwed onto or suspended from the frame in frosty conditions, and stored away in the summer

A method for using such a lighting system provides that the temperature of the ground on to which the emitter is directed is measured and that the emitter is controlled as a function of said temperature. The temperature can be measured directly underneath the panel, or else a reference temperature is determined at a different location on the grass surface, to adapt the emitter intensity to the soil properties.

Often it is not only the easily measured temperature of the ground surface that is relevant, but also the temperature in the soil. Therefore, the temperature in the soil of the grass surface is preferably measured with a ground lance. The moisture content and the salt concentration of the soil can also be determined at the same time. The values thus determined are used to adjust the speed of the mobile lighting system, the intensity of the LED emitters and the infrared emitters and/or the flow velocity at the water nozzles. By optimizing the parameters, in particular at the lamps, the energy consumption of the mobile lighting system can be reduced. As a method for operating such a lighting system it is therefore proposed that the temperature of the ground onto which the emitter is directed is measured, and that the emitter is controlled as a function of said temperature.

In practice, it has been found that a frame with a front and a rear draw shaft is particularly easily steerable. A locking mechanism allows the frame to be moved along a straight line when the draw shaft is locked.

Instead of a motor-driven frame, the lighting system can also be drawn across the grass surface in a straight line. This can be carried out with a rope which is wound around a reel arranged in a stationary position at the edge of the sports field. The same reel as used for the electricity and water supply tube is particularly preferably also used to draw the frame over the grass surface.

### BRIEF DESCRIPTION OF THE DRAWINGS

A frame with one panel of the mobile lighting system is described with reference to drawing FIG.s, wherein:

FIG. 1 illustrates a perspective top view of the mobile lighting system;

FIG. 2 illustrates a transverse side view of the lighting system of FIG. 1;

FIG. 3 illustrates a longitudinal side view of the lighting system of FIG. 1,

FIG. 4 illustrates a top view of the lighting system according to FIG. 1;

FIG. 5 illustrates a blown up of a first detail of FIG. 1;

FIG. 6 illustrates a blown up of a second detail of FIG. I;

FIG. 7 illustrates a view according to FIG. 3 including a heating device and;

FIG. 8 illustrates a view according to FIG. 2 including the heating device

### DETAILED DESCRIPTION OF THE INVENTION

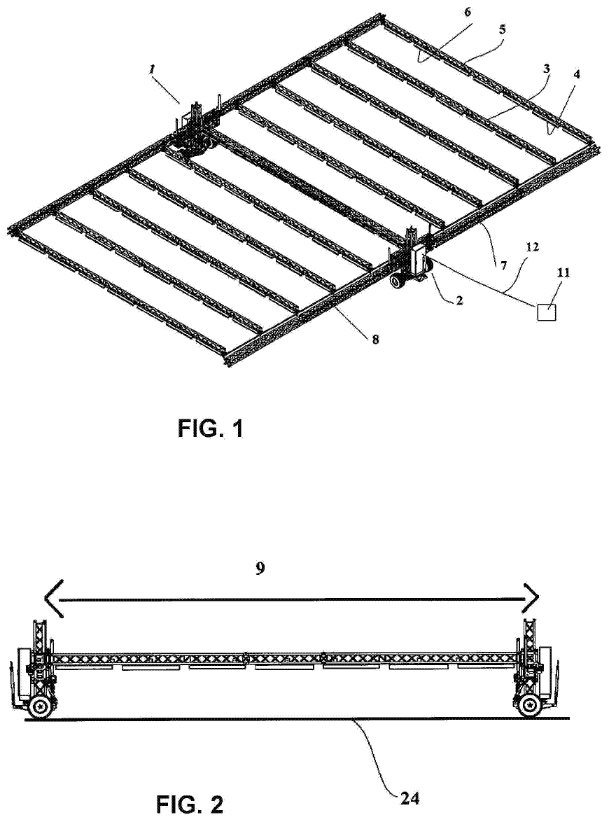

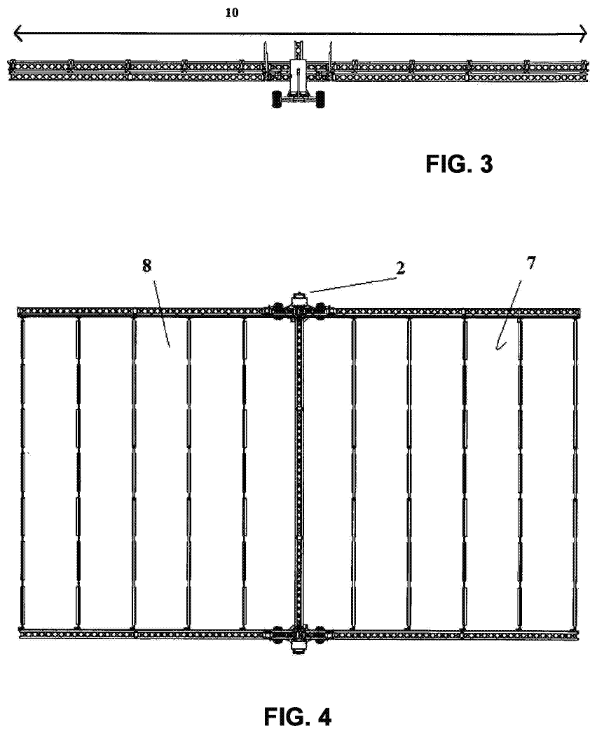

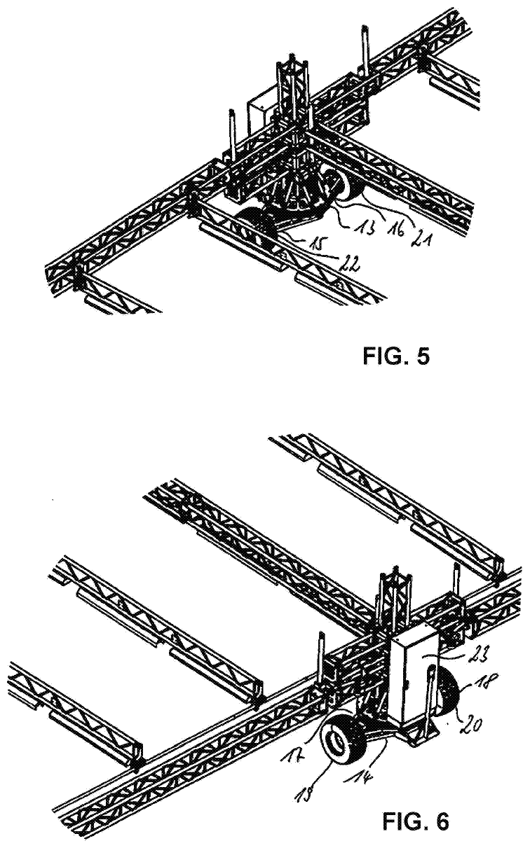

The lighting system shown in FIG. 1 has a movable frame 2, on which a panel 3 is mounted. This panel 3 has infrared emitters 4, water nozzles 5 and LED emitters 6. These LED emitters 6 are implemented as UV emitters.

The panel 3 includes two fold-out panel elements 7, 8, which are attached to the movable frame 2 such they can be folded upwards.

In the folded-out state the panels cover an area of approximately 22 meters by 14 meters. As a result, the lighting system has a span of about 22 meters in one direction and of about 14 meters in the orthogonal direction.

FIG. 1 shows a schematic view of a reel 11, which is connected to the frame 2 via a tube 12. This reel 11 is designed such that it always keeps the tube that runs between the reel 11 and the frame 2 as taut as possible. This means that only the minimum cable length is always resting on the ground or the grass surface. The reel 11 preferably tensions the tube so that the taut tube does not rest on the turf. In the case of larger distances to be bridged between the reel 11 and the frame 2, the tube 12 can be held at a distance above the grass surface using supports (not shown).

The tube 12 conducts both water for the water nozzles 5 on the fold-out panel elements 7, 8 and also electricity for the infrared emitters 4 and the LED emitters 6, which are mounted on the fold-out panel elements 7, 8 and the movable frame 2.

The frame 2 has a draw shaft 13, 14 at each opposite end, which is motor-driven. At the ends of each draw shaft 13, 14 independent wheel suspensions 15, 16 or 17, 18 are positioned, which support rubber tires 19, 20, 21, 22.

A controller 23 allows the frame 2 to be remotely controlled with a plurality of motors (not shown) and the panel 3 to be moved up and down relative to the ground 24.

During the use of the lighting system, the frame with the panels is first moved manually and supported by motors onto a grass surface to be treated. The frame 2 is then connected to the reel 11 via the tube 12. On a football field, a plurality of frames, each with one panel, are preferably arranged side-by-side, so that they can be moved slowly over the football field at the same time.

In the process, atomized water is emitted via the water nozzles 5, which waters the grass surface.

The infrared emitters 4 heat the nebulized water and the turf 24. At the same time the LED emitters illuminate the ground with specific wavelengths of light, which promote the growth of the grass. With the nebulized water which is heated by the infrared emitters 4, the moisture content of the grass surface can be adjusted while at the same time, the grass surface can be heated.

A heating device 25 and 26 is suspended on each of the right and left sides of the controller 23 in

[symbol]

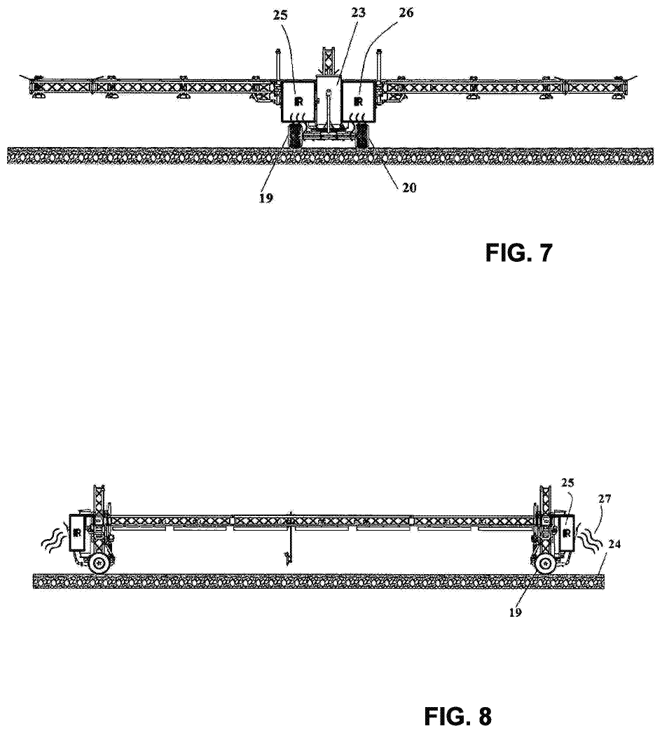

The exemplary embodiment shown in FIGS. 7 and 8. In the cold season, these heating devices are arranged in such a way that infrared radiation 27 radiates onto the ground 24 in the area in front of the wheels 19, 20 in order to heat the grass there and to prevent breakage of frozen grass stems.

What is claimed is:

1. A mobile illumination device, comprising:
a movable frame running on wheels; and
a panel mounted on the movable frame and including infrared radiators and LED radiators.

2. The mobile illumination device according to claim 1, wherein the LED radiators are UV radiators.

3. The mobile illumination device according to claim 1, wherein the panel includes plural panel elements that unfold to achieve a span of more than 10 m.

4. The mobile illumination device according to claim 1, further comprising:
a reel that is capable to wind up a conduit leading to the frame.

5. The mobile illumination device according to claim 4, wherein the conduit conducts electrical power.

6. The mobile illumination device according to claim 1, wherein the frame includes a tow bar.

7. The mobile illumination device according to claim 1, wherein the frame includes one or two motors.

8. The mobile illumination device according to claim 1, wherein the frame includes independent wheel suspension.

9. The mobile illumination device according to claim 1, wherein the frame includes rubber tires.

10. The mobile illumination device according to claim 3, further comprising:
plural movable frames, each including one of the panel elements,
wherein the plural frames are movable together.

11. The mobile illumination device according to claim 1, wherein the panel is elevation adjustable at the frame between 1.2 m and 2.0 m.

12. The mobile illumination device according to claim 1,
wherein the frame includes tires that are capable of moving the frame over a ground, and
wherein a heating device is oriented in a moving direction of the frame and towards the ground.

13. The mobile illumination device according to claim 12, wherein the heating device is removable from the frame.

14. The mobile illumination device according to claim 1, further comprising water nozzles.

15. A method for operating the mobile illumination device according to claim 1, the method comprising the steps:
measuring a temperature of a ground; and
controlling at least one radiator of the infrared radiators and the LD radiators as a function of the temperature of the ground,
wherein the infrared radiators and the LED radiators are oriented towards the ground.

16. A method for operating the mobile illumination system according to claim 14, wherein the water nozzles and a water pressure are controlled so that the water is atomized.
